(19) United States
(12) Patent Application Publication
(10) Pub. No.: US 2010/0118216 A1
(43) Pub. Date: May 13, 2010

(54) IMAGE DISPLAY DEVICE

(76) Inventors: Natsumi Yano, Hokkaido (JP); Kouji Matuhira, Osaka (JP); Tomoo Hiraoka, Osaka (JP); Noriyuki Iwakura, Hokkaido (JP)

Correspondence Address: RATNERPRESTIA, P.O. BOX 980, VALLEY FORGE, PA, 19482, US

(21) Appl. No.: 12/597,203

(22) PCT Filed: Oct. 14, 2008
(86) PCT No.: PCT/JP2008/002891

§ 371 Date: Oct. 23, 2009

(30) Foreign Application Priority Data
Feb. 6, 2008 (JP) 2008 026163

(51) Int. Cl. H04N 5/64

(52) U.S. Cl. 348/836; 348/E05.128

(57) ABSTRACT

An image display device including an image display unit for displaying an image, a chassis disposed on a rear face of the image display unit, a boss member disposed on the cassis, a printed circuit board connected to a tip of the boss member, a first thermal sensor disposed on the printed circuit board at a fixing area of the boss member, a thermal sensor fixture for shielding the printed circuit board, and a casing having a front frame and a rear frame for housing the image display unit and the thermal sensor fixture.

This application is a U.S. National Phase Application of PCT International Application PCT/JP2008/002891.

### TECHNICAL FIELD

The present invention relates to image display devices including an image display unit, such as a plasma display panel and surface-conduction electron-emitter display panel for wall TVs and large monitors.

### BACKGROUND ART

A plasma display panel (hereafter briefly referred to as a “panel”) is a typical AC-type surface discharge panel in which many discharge cells are formed between a front plate and a rear plate that are disposed facing each other. In the front plate, multiple display electrode pairs, each including a pair of scan electrode and a sustain electrode, are formed in parallel on a front glass substrate. A dielectric layer and a protective layer are formed covering these display electrode pairs. In the rear plate, multiple data electrodes are formed in parallel on a rear glass substrate, and a dielectric layer covers these data electrodes. Then, multiple barrier ribs are formed in parallel to data electrodes. A phosphor layer is formed on the surface of the dielectric layer and the side face of the barrier ribs. The front plate and the rear plate are disposed facing each other such that the display electrode pairs and the data electrodes are sterically disposed crossing each other, and sealed. Discharge gas, typically containing 5% xenon in partial pressure ratio, is filled in an internal discharge space. A discharge cell is formed at an area where the display electrode pair faces the data electrode. In a panel as configured above, an ultraviolet ray is generated by gas discharge in each discharge cell. This ultraviolet ray excites each phosphor of red (R), green (G), and blue (B) to emit light for color display.

In general, a subfield method is adopted as a panel-driving method. More specifically, one field period is divided into multiple subfields. Grayscale display is achieved by combinations of subfields to emit light.

Each subfield includes an initializing period, address period, and sustain period. In the initializing period, an initializing discharge occurs so as to form a wall charge needed for a subsequent address operation on each electrode. At the same time, priming particles (a detonator for discharge=Excited particles) are generated so as to reliably generate address discharge. In the address period, an address pulse voltage is selectively applied to discharge cells to be displayed. This generates address discharge and forms the wall charge (this operation is hereafter also referred to as “address”). In the sustain period, a sustain pulse voltage is applied alternately to the display electrode pair including the scan electrode and the sustain electrode, so as to generate a sustain discharge in the discharge cells where the address discharge has occurred. This makes phosphor layers of corresponding discharge cells emit light, and thus an image is displayed.

In the above operations, heat is generated in the discharge cells in proportion to the number of discharges. Accordingly, a temperature of the panel itself increases by this heat. In addition, a brighter display image requires more number of discharges. A brighter display image thus results in a higher panel temperature. Furthermore, it is generally known that a discharge characteristic changes depending on the discharge cell temperature in this type of panels. Accordingly, too high panel temperature causes unstable discharge. This risks degradation in the image display quality. On the other hand, too low panel temperature also degrades the image display quality, and risks failure in light emission.

Therefore, diversifying methods have been proposed to prevent degradation in the image display quality that may be caused depending on the panel temperature.

For example, a structure of a conventional plasma display device includes two thermal sensors for detecting the temperature of a rear panel face and ambient temperature, a drive condition switching circuit, and a drive circuit. The drive condition switching circuit changes a display drive condition for the panel when temperatures detected by these thermal sensors are out of predetermined operating ranges and enter different operating ranges. The drive circuit executes data drive, scan drive, and common drive of the panel in accordance with this drive condition switching circuit so as to enable appropriate light-emission and display in real time (For example, refer to Patent Document 1).

In the conventional plasma display device, these thermal sensors monitor the temperature of the panel rear face and the ambient temperature in order to achieve display drive conditions most appropriate for the panel surface temperature that follows the ambient temperature after turning on power. When these thermal sensors detect that rear panel face temperature or the ambient temperature is higher than predetermined temperature ranges in the conventional plasma display device, the drive condition switching circuit can change the panel drive condition and applies a scan pulse to extend a scan time for inputting a data pulse.

As described above, in a panel module whose panel characteristic changes depending on a temperature characteristic when the panel is lighted or after the panel temperature is stabilized, the prior art optimizes the display drive conditions corresponding to this temperature characteristic so as to prevent occurrence of failures in the address operation and erroneous lighting of the panel.

Recently, however, brighter images have been studied for further improving the display quality. Therefore, in a plasma display device configured to increase the light-emission luminance by increasing a discharge current of the panel, the panel temperature further increases, and thus the heat value from circuits also increases. This degrades accuracy of measurement of panel temperature by the thermal sensor attached to the rear face of the panel. Accordingly, failures including erroneous lighting are now not completely preventable.

In addition, further cost reduction by reducing the number of components configuring the plasma display device has been strongly demanded. Therefore, it is becoming difficult to use a separate device or printed circuit board for mounting two thermal sensors separately for measuring different temperatures. If these two thermal sensors are mounted on a single board, it becomes difficult to detect sensor values that meet an aim of measuring different temperatures. Accordingly, a temperature in an image display unit needs to be calculated further accurately so as to drive in a way appropriate for the temperature of the image display unit in image display devices having an image display unit that generates large heat, such as a plasma display panel and surface conduction electron-emitter display panel.

### Patent Document 1: Japanese Patent Unexamined Publication No. 2003-280572

### SUMMARY OF THE INVENTION

An image display device of the present invention includes an image display unit for displaying an image, a chassis disposed on a rear face of the image display unit, a boss member installed to the chassis, a printed circuit board connected to a tip of the boss member, a first thermal sensor disposed on the printed circuit board at a fixing area of the boss member, a thermal sensor fixture for thermally shielding the printed circuit board, and a casing having a front frame and a rear frame and housing the image display unit and the thermal sensor fixture.

With this structure, a highly accurate measurement of a temperature of the image display unit becomes achievable without being affected by the heat released such as from a drive circuit board.

The image display device of the present invention may further include a second thermal sensor on the printed circuit board at a position facing the rear frame, and a condition temperature determination circuit for calculating a temperature of the image display unit based on the first thermal sensor and the second thermal sensor.

### BRIEF DESCRIPTION OF DRAWINGS

FIG. 1 is an exploded perspective view illustrating an example of a panel structure as an image display unit of an image display device in accordance with a first exemplary embodiment of the present invention.

FIG. 2 is an electrode layout of the panel.

FIG. 3 is a subfield structure of a plasma display device in accordance with the first exemplary embodiment of the present invention.

FIG. 4 is a chart illustrating a drive voltage waveform applied to each electrode on the panel of the plasma display device in accordance with the first exemplary embodiment of the present invention.

FIG. 5 is a circuit block diagram of the plasma display device in the first exemplary embodiment of the present invention.

FIG. 6 is a circuit diagram of a scan electrode drive circuit in accordance with the first exemplary embodiment of the present invention.

FIG. 7 is a circuit diagram of a data electrode drive circuit in accordance with the first exemplary embodiment of the present invention.

FIG. 8 is an exploded perspective view of an example of a structure of the plasma display device in accordance with the first exemplary embodiment of the present invention.

FIG. 9 is a sectional view taken along line 9-9 in FIG. 8.

FIG. 10 is an exploded perspective view of an example of a structure of a plasma display device as an image display device in accordance with a second exemplary embodiment of the present invention.

FIG. 11 is a sectional view taken along line 11-11 in FIG. 10.

FIG. 12 is a circuit block diagram of the plasma display device in accordance with the second exemplary embodiment of the present invention.

FIG. 13 is a chart illustrating the relationship of output values of two thermal sensors, a panel temperature, and a condition temperature relative to the time after the power is turned on to display an all-white image on the entire screen of the plasma display device in accordance with the second exemplary embodiment of the present invention.

FIG. 14 is a chart illustrating the relationship of output values of two thermal sensors, a panel temperature, and a condition temperature relative to the time after the power is turned on to display an all-black image on the entire screen of the plasma display device in accordance with the second exemplary embodiment of the present invention.

REFERENCE MARKS IN THE DRAWINGS
2 Front frame
3 Back cover (Rear frame)
4 Ventilating hole
5 Ventilation area
10 Panel
81 Heat-conducting sheet
12 Chassis
13a Data electrode drive circuit board
13b Scan electrode drive circuit board
13c Sustain electrode drive circuit board
14 Power circuit board
15 Small-signal processing circuit board
16 Thermal sensor fixture
17 Shielding wall
18 Tuner board
19 FPC
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode drive circuit
43 Scan electrode drive circuit
44 Sustain electrode drive circuit
45 Timing generating circuit
48, 148 Condition temperature determination circuit
49 Thermal sensor (First thermal sensor)
50, 60 Sustain pulse generating circuit
51, 56 Power recovery circuit
52, 57 Clamping circuit
53 Initializing waveform generating circuit
54 Scan pulse generating circuit
55 Address pulse generating circuit
58 Address pulse output circuit
59 Ambient temperature estimation circuit
61 Thermal sensor (second thermal sensor)
100, 101 Plasma display device (image display device)
121, 122, 123, 161 Boss member
Q1, Q2, Q3, Q4, Q11, Q12, Q13, Q14, Q21, Q31, Q32, Q33, Q34, QH1 to QHn, QL1 to QLn Switching element
C1, C10, C11, C21, C31 Capacitor
L1, L31 Inductor
D11, D12, D21, D31, D32 Diode

### DETAILED DESCRIPTION OF PREFERRED EMBODIMENTS

Exemplary embodiments of the present invention are described below with reference to drawings.

### First Exemplary Embodiment

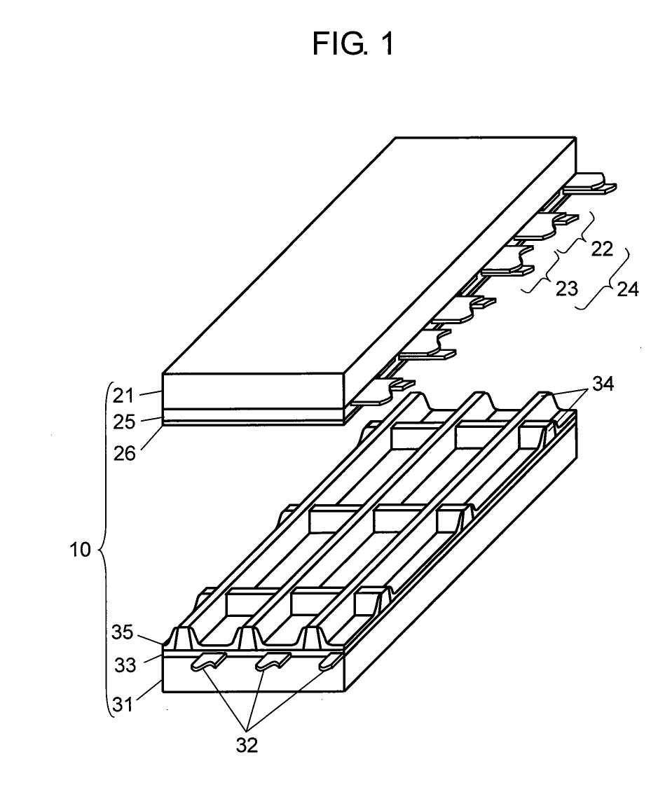

FIG. 1 is an exploded perspective view of an example of structure of panel 10 as an image display unit of an image display device in the first exemplary embodiment of the present invention. The following description refers to a plasma display device including panel 10 as an example of the image display device in this exemplary embodiment. However, the image display device is not limited to the plasma display device. It includes other devices having an image display unit with large heat value, such as a surface-conduction electron-emitter display panel.

First, a structure of panel 10 in the plasma display device is detailed. As shown in FIG. 1, multiple display electrode pairs 24, each of which including scan electrode 22 and sustain electrode 23, are formed on front plate 21 made of glass in panel 10. Dielectric layer 25 is formed covering scan electrode 22 and sustain electrode 23. Protective layer 26 is formed on this dielectric layer 25.

Protective layer 26 is made of a material mainly containing MgO, which is a proven panel material for reducing discharge start voltage in a discharge cell. MgO also has a large secondary electron emission coefficient and thus shows good durability when neon (Ne) and xenon (Xe) gases are encapsulated.

Multiple data electrodes 32 are formed on rear plate 31, and dielectric layer 33 is formed covering data electrodes 32. Barrier ribs 34 are formed in a grid on this dielectric layer 33. Phosphor layer 35 that emits light in each color of red (R), green (G), and blue (B), respectively, is provided on a side face of barrier ribs 34 and dielectric layer 33.

These front plate 21 and rear plate 31 are disposed facing each other such that display electrode pairs 24 and data electrodes 32 cross each other with a small discharge space in between. Peripheries of these plates are sealed with a sealant such as glass frit. A gas mixture of typically neon and xenon is filled as discharge gas in the discharge space. Barrier ribs 34 partition the discharge space into multiple sections, and a discharge cell is formed at each cross-section of display electrode pair 24 and data electrode 32. An image is displayed by discharging electricity and emitting light from these discharge cells.

The structure of panel 10 is not limited to the above structure. For example, striped barrier ribs may be provided.

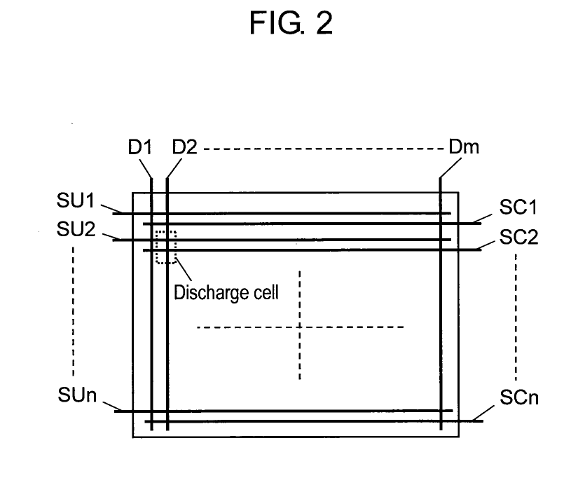

FIG. 2 is an electrode layout in panel 10 in the exemplary embodiment of the present invention. Panel 10 includes the n number of scan electrodes SC1 to SCn (scan electrodes 22 in FIG. 1) and the n number of sustain electrodes SU1 to SUn (sustain electrodes 23 in FIG. 1) row-wise, and the m number of data electrodes D1 to Dm (data electrode 32 in FIG. 1) column-wise. The discharge cell is formed at a cross-section where a pair of scan electrode SCi (i=1 to n) and sustain electrode SUi crosses one data electrode Dj (j=1 to m). In the discharge space, the m×n number of discharge cells is formed. As shown in FIGS. 1 and 2, large interelectrode capacitance Cp exists between scan electrodes SC1 to SCn and sustain electrodes SU1 to SUn because scan electrode SCi and sustain electrode SUi are a parallel pair. Interelectrode capacitance also exists at a cross-section where scan electrode SCi and sustain electrode SUi crosses data electrode Dj.

Next, a drive voltage waveform for driving panel 10 and its operation are outlined. The plasma display device in the first exemplary embodiment adopts a subfield method. In other words, one field period is divided into multiple subfields. Grayscale display is achieved by controlling emission and non-emission of light from each discharge cell for each subfield. Each subfield includes an initializing period, an address period, and a sustain period.

In each subfield, initializing discharge occurs in the initializing period so as to form a wall charge needed for subsequent address discharge on each electrode. In addition, the initializing discharge serves to generate priming particles (a detonator for discharge=Excited particles) for stable generation of address discharge by reducing discharge delay. The initializing operation at this point includes the initializing operation for generating initializing discharge in all discharge cells (hereafter referred to as “all-cell initialization”) and the initializing operation for generating initializing discharge only in selected discharge cells where sustain discharge took place in an immediately preceding subfield (hereafter referred to as “selective initialization”).

In the address period, selective address discharge occurs so as to form a wall charge in discharge cells to emit light in a subsequent sustain period. In the sustain period, the number of sustain pulses proportional to luminance weight is alternately applied to display electrode pair 24. This generates sustain discharge in discharge cells where address discharge has occurred, and the light is emitted. A proportional constant in this operation is called “luminance magnification.”

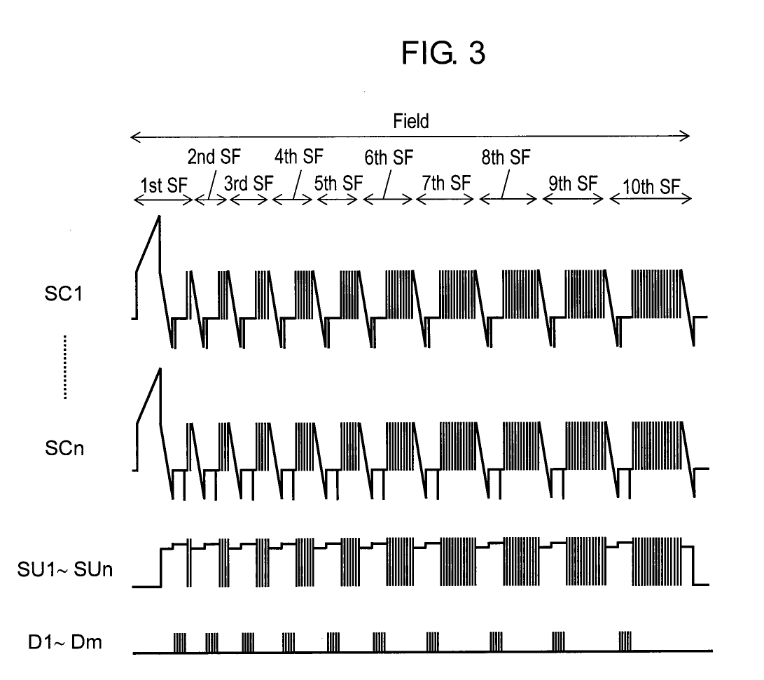

FIG. 3 illustrates a subfield structure in the first exemplary embodiment of the present invention. FIG. 3 shows an outline of a drive waveform in one field period in the subfield method, and the drive voltage waveform is detailed later.

In this exemplary embodiment, one field includes ten subfields (first SF, second SF . . . tenth SF), and each subfield is given luminance weight of 1, 2, 3, 6, 11, 18, 30, 44, 60, and 80, respectively. In the initializing period of the first SF, the all-cell initialization takes place. In the initializing period of the second SF to the tenth SF, the selective initialization takes place. Accordingly, the light emission not related to an image to be displayed occurs related to discharge only in the all-cell initialization in the first SF. The brightness of a black display area in discharge cells where no sustain discharge is generated is only a faint light in the all-cell initialization. This achieves display of a high contrast image. In the sustain period of each subfield, the number of sustain pulses calculated by multiplying the luminance weight of each subfield by a predetermined luminance magnification is applied to display electrode pair 24, respectively.

However, in the first exemplary embodiment, the number of subfields or the luminance weight of each subfield is not limited to the above values. A subfield structure may be switched based on image signals, and so on.

In the exemplary embodiment, luminance magnification is not fixed. It is changed based on a temperature detected by a thermal sensor described later. In this way, power consumption in panel 10 is controlled to keep an appropriate temperature for panel 10. This is detailed later.

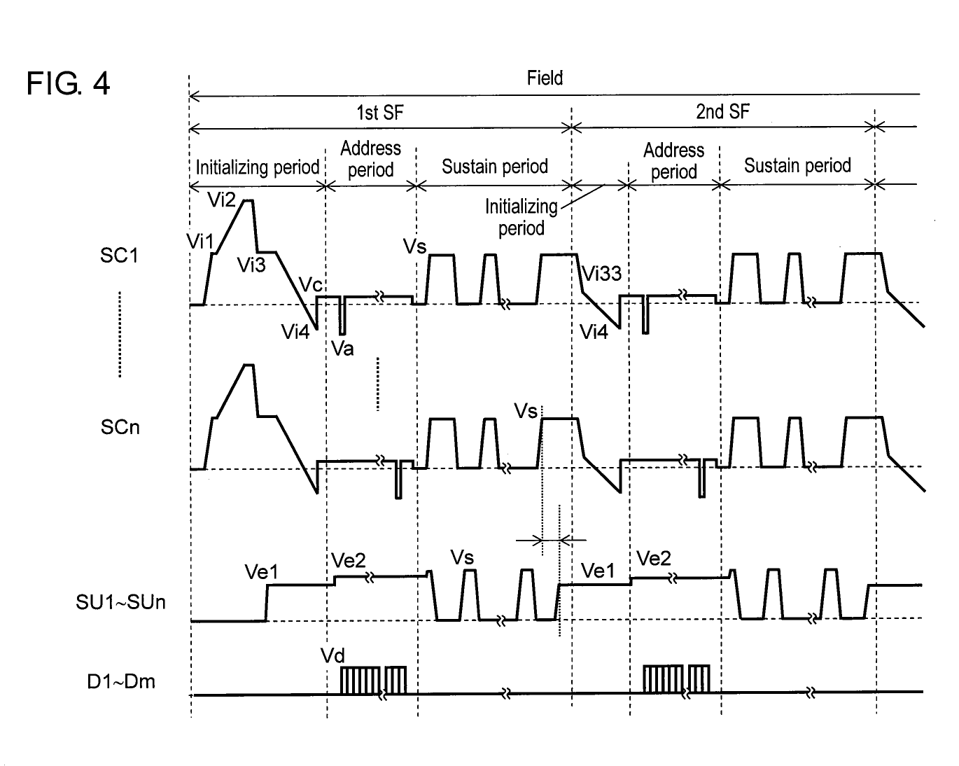

FIG. 4 is a drive voltage waveform applied to each electrode of panel 10 of the plasma display device in the first exemplary embodiment of the present invention. FIG. 4 shows the drive voltage waveform for two subfields, i.e., a subfield to which the all-cell initialization is applied (hereafter referred to as the “all-cell initialized subfield”), and a subfield to which the selective initialization is applied (hereafter referred to as the “selectively initialized subfield”). A similar drive voltage waveform is also applied to other subfields.

First, the first SF, which is the all-cell initialized subfield, is described. In a first half of the initializing period of the first SF, 0 (V) is applied to data electrodes D1 to Dm and sustain electrodes SU1 to SUn, respectively. Inclined waveform voltage is applied to scan electrodes SC1 to SCn with respect to sustain electrodes SU1 to SUn. This inclined waveform voltage (hereafter referred to as the “ramp-rise waveform voltage”) moderately increases from voltage Vi1, which is not greater than the discharge start voltage, to voltage Vi2, which is higher than the discharge start voltage.

While this ramp-rise waveform voltage is on the increase, a faint initializing discharge occurs continuously between scan electrodes SC1 to SCn and sustain electrodes SU1 to SUn, and data electrodes D1 to Dm. Then, a negative wall voltage is accumulated on upper parts of scan electrodes SC1 to SCn, and a positive wall voltage is accumulated on upper parts of data electrodes D1 to Dm and upper parts of sustain electrodes SU1 to SUn. The wall voltage on the upper part of electrode is voltage generated by the wall charge accumulated on the dielectric layer, protective layer, phosphor layer, and so on that cover the electrode.

In the latter half of the initializing period, positive voltage Ve1 is applied to sustain electrodes SU1 to SUn, and 0 (V) is applied to data electrodes D1 to Dm. An inclined waveform voltage is applied to scan electrodes SC1 to SCn with respect to sustain electrodes SU1 to SUn. This inclined waveform voltage (hereafter referred to as the “ramp-down waveform voltage”) moderately decreases from voltage Vi3, which is not greater than the discharge start voltage, to voltage Vi4, which is higher than the discharge start voltage. During this time, a faint initializing discharge continuously occurs between scan electrodes SC1 to SCn and sustain electrodes SU1 to SUn, and data electrodes D1 to Dm. Then, the negative wall voltage on upper parts of scan electrodes SC1 to SCn and the positive wall voltage on upper parts of sustain electrodes SU1 to SUn are weakened so that the positive wall voltage on upper parts of data electrodes D1 to Dm is adjusted to a value appropriate for the address operation. This completes the all-cell initialization that generates initializing discharge in all discharge cells.

As shown in the initializing period of the second SF in FIG. 4, the drive voltage waveform that omits the first half of the initializing period may be applied to each electrode. More specifically, voltage Ve1 is applied to sustain electrodes SU1 to SUn, 0 V is applied to data electrodes D1 to Dm, and the ramp-down waveform voltage that moderately decreases from voltage Vi33 to voltage Vi4 is applied to scan electrodes SC1 to SCn. This generates a faint initializing discharge in discharge cells in which sustain discharge has occurred in the sustain period in a previous subfield. The wall voltage on the upper part of scan electrode SC1 and the upper part of sustain electrode SUi are thus weakened. In addition, in discharge cells where sufficient positive wall voltage is accumulated on the upper part of data electrode Dk (k=1 to m), an excessive portion of this wall voltage is discharged so as to adjust to the wall voltage appropriate for the address operation. On the other hand, in discharge cells where no sustain discharge has occurred in the previous subfield, no discharge takes place, and the wall charge accumulated on completing the initializing period in the previous subfield is sustained. As described above, if the first half of the initializing operation is omitted, the initializing operation becomes the selective initialization that executes initializing discharge in discharge cells where the sustain operation has taken place in the sustain period in the immediately-preceding subfield.

In the subsequent address period, voltage Ve2 is applied to sustain electrodes SU1 to SUn, and voltage Vc is applied to scan electrodes SC1 to SCn.

Then, negative scan pulse voltage Va is applied to scan electrode SC1 in the first line, and positive address pulse voltage Vd is applied to data electrode Dk (k=1 to m) of discharge cells to emit light in the first line, out of data electrodes D1 to Dm. A voltage difference at an intersection between data electrode Dk and scan electrode SC1 is a sum of a difference in external applied voltages (Vd−Va), and a difference between wall voltages on data electrode Dk and scan electrode SC1. This voltage difference exceeds the discharge start voltage. Accordingly, discharge occurs between data electrode Dk and scan electrode SC1. In addition, since voltage Ve2 is applied to sustain electrodes SU1 to SUn, a voltage difference between sustain electrode SU1 and scan electrode SC1 is a sum of a difference in external applied voltages (Ve2−Va) and a difference between wall voltages on sustain electrode SU1 and scan electrode SC1. Here, a condition that likely to generate discharge, although discharge does not actually takes place, can be created between sustain electrode SU1 and scan electrode SC1 by setting voltage Ve2 that slightly falls below the discharge start voltage. Triggered by discharge generated between data electrode Dk and scan electrode SC1, discharge can be generated between sustain electrode SU1 and scan electrode SC1 in an area where they cross with data electrode Dk. In this way, address discharge occurs in a discharge cell to emit light. The positive wall voltage is accumulated on scan electrode SC1, the negative wall voltage is accumulated on sustain electrode SU1, and the negative wall voltage is accumulated also on data electrode Dk.

As described above, address discharge occurs in discharge cells to emit light in the first line, and the wall voltage is accumulated on each electrode in the address operation. On the other hand, voltage at cross sections of data electrodes D1 to Dm, where no address pulse voltage Vd is applied, and scan electrode SC1 does not exceed the discharge start voltage, and thus address discharge does not occur. The above address operation is executed up to discharge cells in the nth line, and the address period is completed.

In the subsequent sustain period, positive sustain pulse voltage Vs is first applied to scan electrodes SC1 to SCn, and a ground potential that becomes a base potential, i.e., 0 V, is applied to sustain electrodes SU1 to SUn. Then, a voltage difference between scan electrode SCi and sustain electrode SUi becomes the sum of sustain pulse voltage Vs and a difference between wall voltages on scan electrode SCi and sustain electrode SUi in discharge cells where address discharge has occurred. This voltage difference exceeds the discharge start voltage.

Accordingly, sustain discharge occurs between scan electrode SCi and sustain electrode SUi, and phosphor layer 35 emits light by ultraviolet ray generated at this point. Then, the negative wall voltage is accumulated on scan electrode SCi, and the positive wall voltage is accumulated on sustain electrode SUi. Still more, the positive wall voltage is also accumulated on data electrode Dk. Sustain discharge does not occur in discharge cells where address discharge has not occurred in the address period, and thus the wall voltage accumulated on completing the initializing period is sustained.

Next, 0 V, which is a base potential, is applied to scan electrodes SC1 to SCn, and sustain pulse voltage Vs is applied to sustain electrodes SU1 to SUn, respectively. Then, a voltage difference on sustain electrode SUi and scan electrode SCi exceeds the discharge start voltage in discharge cells where sustain discharge has occurred. Accordingly, sustain discharge occurs again between sustain electrode SUi and scan electrode SCi. The negative wall voltage is thus accumulated on sustain electrode SUi, and the positive wall voltage is accumulated on scan electrode SCi. In the same way, the number of sustain pulses, which is calculated by multiplying the luminance weight by luminance magnification, is applied alternately to scan electrodes SC1 to SCn and sustain electrodes SU1 to SUn so as to give potential difference between electrodes of display electrode pair 24. This enables continuous sustain discharge in discharge cells where address discharge has occurred in the address period.

At the last of the sustain period, a so-called narrow pulse voltage difference is applied between scan electrodes SC1 to SCn and sustain electrodes SU1 to SU so as to adjust the wall voltage on scan electrode SCi and sustain electrode SUi while the positive wall voltage remains on data electrode Dk.

In subsequent subfields, the operation is mostly the same as that described above, except for the number of sustain pulses in the sustain period, and thus its description is omitted. This is the outline of the drive voltage waveform applied to each electrode of panel 10 in the first exemplary embodiment.

If the first SF to the tenth SF have a luminance weight of 1, 2, 3, 6, 11, 18, 30, 44, 60, and 80, respectively, the number of sustain pulses in each subfield is 1, 2, 3, 6, 11, 18, 30 44, 60, 80, respectively, at one-fold luminance magnification. At two-fold luminance magnification, each luminance weight is doubled, and becomes 2, 4, 6, 12, 22, 36, 60, 88, 120, and 160. At three-fold luminance magnification, the luminance weight is tripled, and becomes 3, 6, 9, 18, 33, 54, 90, 132, 180, and 240. In this exemplary embodiment, as described above, this luminance magnification is changed based on a temperature detected by the thermal sensor described later so as to control the total number of sustain pulses in one field period. In this way, power consumption in panel 10 is controlled to keep an appropriate temperature for panel 10.

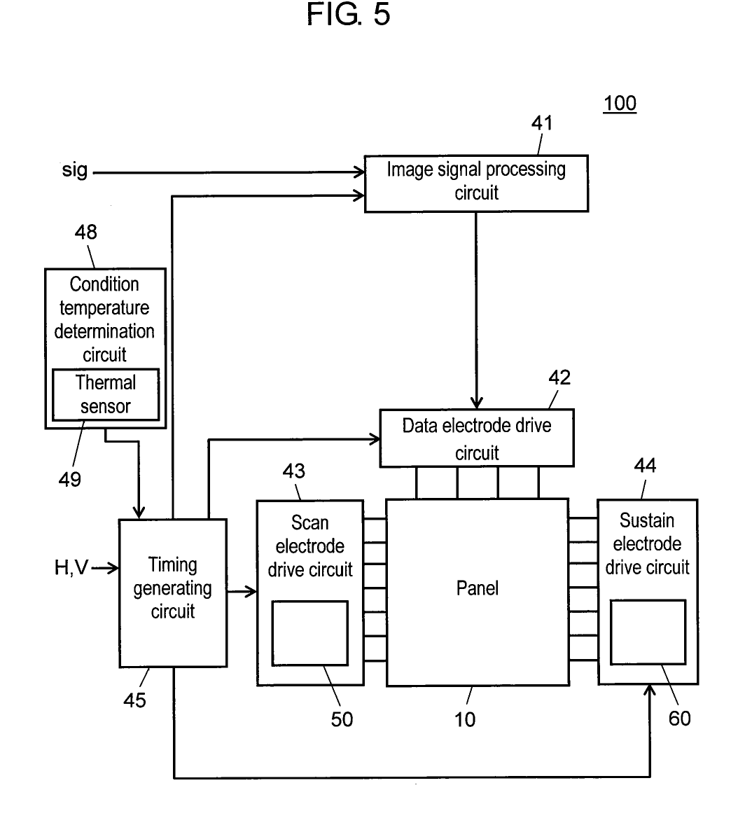

Next, a structure of the plasma display device in this exemplary embodiment is described. FIG. 5 is a circuit block diagram of plasma display device 100 in the first exemplary embodiment of the present invention. Plasma display device 100 includes panel 10, image signal processing circuit 41, data electrode drive circuit 42, scan electrode drive circuit 43, sustain electrode drive circuit 44, timing generating circuit 45, condition temperature determination circuit 48, and power circuit (not illustrated) for supplying required power to each circuit block.

Image signal processing circuit 41 converts input image signal sig to image data that indicates emission and non-emission of light from each subfield. Data electrode drive circuit 42 converts image data in each subfield to a signal corresponding to each of data electrodes D1 to Dm, and drives data electrodes D1 to Dm.

Condition temperature determination circuit 48 includes thermal sensor 49 as a first thermal sensor, which is configured of a generally-known element, such as a thermo couple, for detecting temperatures. Condition temperature determination circuit 48 calculates a temperature of panel 10 based on an output of thermal sensor 49. This calculated temperature of panel 10 is called a condition temperature. Condition temperature determination circuit 48 compares the temperature of panel 10 calculated based on thermal sensor 49 with a predetermined temperature threshold, and outputs a signal indicating a comparison result. More specifically, whether or not the detected temperature is below the temperature threshold is compared, and if the detected temperature is the same or higher than the temperature threshold, a signal indicating how much higher than the temperature threshold is output to timing generating circuit 45.

Timing generating circuit 45 generates a range of timing signals for controlling the operation of each circuit block based on horizontal synchronizing signal H, vertical synchronizing signal V, and output from condition temperature determination circuit 48; and supplies these timing signals to circuit blocks, respectively. In this exemplary embodiment, as already described, the luminance magnification is controlled based on the temperature detected by thermal sensor 49. Accordingly, a corresponding timing signal is output to scan electrode drive circuit 43 and sustain electrode drive circuit 44. This enables the control of the total number of sustain pulses in one field period so as to control power consumption. Accordingly, the panel is controlled to keep an appropriate temperature.

Scan electrode drive circuit 43 includes an initializing waveform generating circuit (not illustrated) for generating the initializing waveform voltage applied to scan electrodes SC1 to SCn in the initializing period, sustain pulse generating circuit 50 for generating the sustain pulse voltage applied to scan electrodes SC1 to SCn in the sustain period, and a scan pulse generating circuit (not illustrated) for generating the scan pulse voltage applied to scan electrodes SC1 to SCn in the address period. Scan electrode drive circuit 43 drives each of scan electrodes SC1 to SCn based on the timing signal. Sustain electrode drive circuit 44 includes sustain pulse generating circuit 60 and a circuit for generating voltage Ve1 and voltage Ve2, and drives sustain electrodes SU1 to SUn based on the timing signal.

In each of the electrode drive circuits that generates discharge from discharge cells by driving each electrode, high voltage ranging from several tens of volts to hundred and several tens of volts is applied to each electrode, and extremely large current of around several tens of amperes needs to travel for discharge. Therefore, each electrode drive circuit generates extremely large Joule heating. In addition, since panel 10 displays an image by the combination of emission and non-emission of light from each discharge cell, discharge from each discharge cell differs according to a pattern of display image. Accordingly, the heat generated also greatly varies depending on a pattern of display image.

On the other hand, signals handled in image signal processing circuit 41 and timing generating circuit 45 involve voltage from several volts to dozen volts at most, and thus they are significantly lower than that of the above drive circuits (these circuits are hereafter collectively called “small-signal processing circuit”). Current that needs to be traveled is also significantly small, and variations in the current level is also relatively small since the operation is mostly fixed regardless of patterns of display images. Accordingly, Joule heating generated is sufficiently small, and its variations are also small.

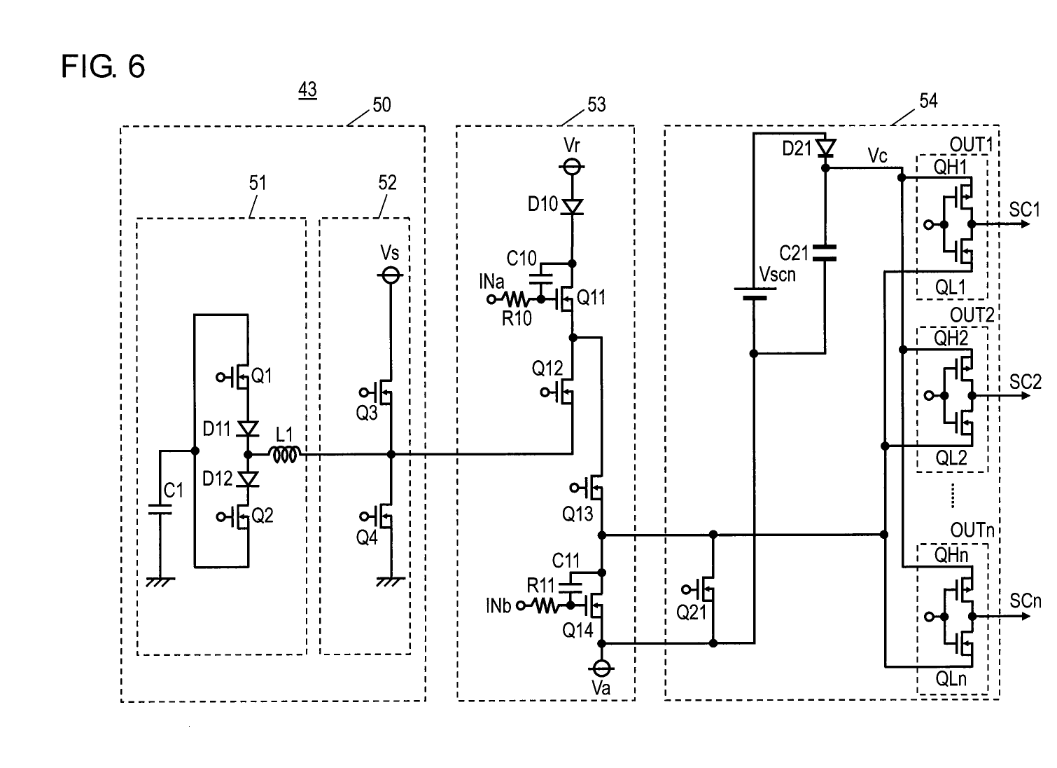

Next, each electrode drive circuit is detailed. First, details and the operation of scan electrode drive circuit 43 are described. FIG. 6 is a circuit diagram of scan electrode drive circuit 43 in the first exemplary embodiment of the present invention. Scan electrode drive circuit 43 includes sustain pulse generating circuit 50 for generating a sustain pulse, initializing waveform generating circuit 53 for generating an initializing waveform, and scan pulse generating circuit 54 for generating a scan pulse.

Sustain pulse generating circuit 50 includes power recovery circuit 51 and clamping circuit 52. Power recovery circuit 51 includes power-recovery capacitor C1, switching elements Q1 and Q2, back-flow preventing diodes D11 and D12, and resonance inductor L1. Power-recovery capacitor C1 has a sufficiently large capacitance compared to interelectrode capacitance Cp, and is charged to about a half of voltage Vs, i.e., Vs/2, so that capacitor C1 can serve as a power source for power recovery circuit 51. Clamping circuit 52 includes switching element Q3 for clamping scan electrodes SC1 to SCn to voltage Vs, and switching element Q4 for clamping scan electrodes SC1 to SCn to 0 V. Clamping circuit 52 also generates sustain pulse voltage Vs based on a timing signal output from timing generating circuit 45.

For example, to launch the sustain pulse waveform, switching element Q1 is turned on, and interelectrode capacitance Cp and inductor L1 are resonated so as to supply power from power-recovery capacitor C1 to scan electrodes SC1 to SCn through switching element Q1, diode D11, and inductor L1. Then, switching element Q3 is turned on when voltage of scan electrodes SC1 to SCn comes close to Vs so as to clamp scan electrodes SC1 to SCn to voltage Vs.

Contrarily, to end the sustain pulse waveform, switching element Q2 is turned on, and interelectrode capacitance Cp and inductor L1 are resonated so as to recover power from interelectrode capacitance Cp to power-recovery capacitor C1 through inductor L1, diode D12, and switching element Q2. When voltage of scan electrodes SC1 to SCn reaches close to 0 V, switching element Q4 is turned on to clamp scan electrodes SC1 to SCn to 0 V.

Initializing waveform generating circuit 53 includes a Miller integrating circuit, which includes switching element Q11, capacitor C10, and resistor R10, for generating ramp-rise waveform voltage that moderately increases up to voltage Vi2 in a ramp state; another Miller integrating circuit, which includes switching element Q14, capacitor C11, and resistor R11, for generating ramp-down waveform voltage that moderately decreases down to predetermined initializing voltage Vi4; a separation circuit using switching element Q12; and a separation circuit using switching element Q13. Initializing waveform generating circuit 53 generates aforementioned initializing waveform based on the timing signal output from timing generating circuit 45. In FIG. 6, input terminals of the Miller integrating circuits are indicated as input terminal INa and input terminal INb, respectively.

For example, to generate the ramp-rise waveform voltage in the initializing waveform, input terminal INa is switched to “Hi” by applying a predetermined voltage (e.g. 15 V) to input terminal INa. Then, a constant current travels from resistor R10 to capacitor C10, the source voltage of switching element Q11 increases in the ramp state, and the output voltage of scan electrode drive circuit 43 also starts to increase in the ramp state.

To generate the ramp-down waveform voltage in the initializing waveform in the all-cell initialization and the selective initialization, input terminal INb is switched to “Hi” by applying a predetermined voltage (e.g., 15 V) to input terminal INb. Then, a constant current travels from resistor R11 to capacitor C11. Drain voltage of switching element Q14 decreases in the ramp state, and the output voltage of scan electrode drive circuit 43 also starts to decrease in the ramp state.

Scan pulse generating circuit 54 includes switch circuits OUT1 to OUTn that output the scan pulse voltage to each of scan electrodes SC1 to SCn; switching element Q21 for clamping the low-voltage side of switch circuits OUT1 to OUTn to voltage Va; and diode D21 and capacitor C21 for applying voltage Vc, in which voltage Va is superimposed on voltage Vscn, to the high-voltage side of switch circuits OUT1 to OUTn. Switch circuits OUT1 to OUTn include switching elements QH1 to QHn for outputting voltage Vc and switching elements QL1 to QLn for outputting voltage Va, respectively. Based on a timing signal output from timing generating circuit 45, scan pulse voltage Va applied to scan electrodes SC1 to SCn is sequentially generated in the address period. Scan pulse generating circuit 54 outputs the voltage waveform of initializing waveform generating circuit 53 in the initializing period, and outputs the voltage waveform of sustain pulse generating circuit 50 in the sustain period without any change.

As described above, an extremely large current needs to be traveled in scan electrode drive circuit 43 so as to generate initializing discharge, address discharge, and sustain discharge by driving scan electrodes SC1 to SCn. This results in generating large Joule heating. Furthermore, since generation of sustain discharge varies depending on display images, the heat generated also greatly varies depending on patterns of display images.

In the first exemplary embodiment, the Miller integrating circuit employing FET, which is practical and has a relatively simple structure, is adopted in initializing waveform generating circuit 53. However, the present invention is not limited to this structure. Any circuit is applicable as long as the ramp-rise waveform voltage and the ramp-down waveform voltage can be generated.

Although not illustrated in a drawing, the sustain pulse generating circuit in sustain electrode drive circuit 44 has the same structure as sustain pulse generating circuit 50, and includes a power recovery circuit for recovering power used for driving sustain electrodes SU1 to SUn for reuse, a switching element for clamping sustain electrodes SU1 to SUn to voltage Vs, and a switching element for clamping sustain electrodes SU1 to SUn to 0 V; so as to generate sustain pulse voltage Vs.

Also in sustain electrode drive circuit 44, an extremely large current needs to be traveled so as to generate sustain discharge by driving sustain electrodes SC1 to SCn. Accordingly, this generates large Joule heating, and the heat generated greatly varies depending on patterns of display images.

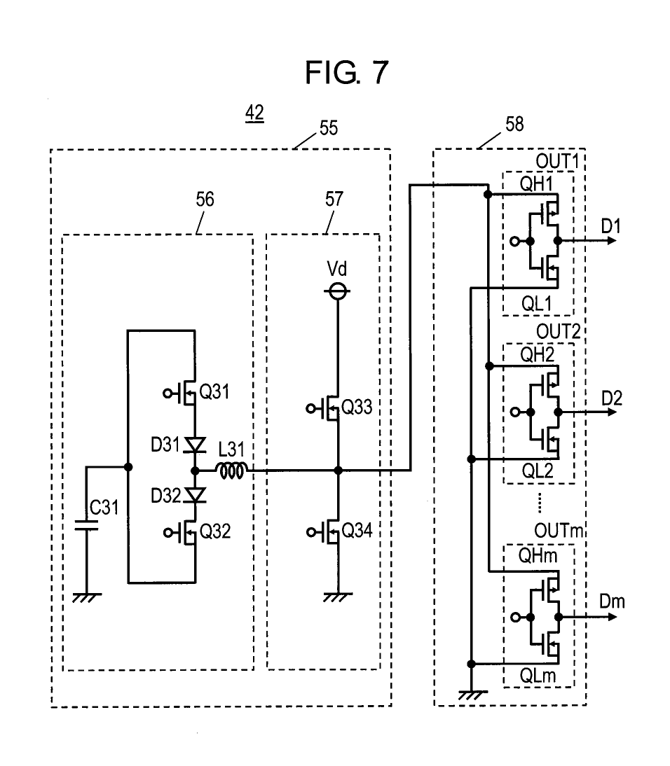

Next, details and the operation of data electrode drive circuit 42 are described. FIG. 7 is a circuit diagram of data electrode drive circuit 42 in the first exemplary embodiment of the present invention. Data electrode drive circuit 42 includes address pulse generating circuit 55 and address pulse output circuit 58.

Address pulse generating circuit 55 includes power recovery circuit 56 and clamping circuit 57. Power recovery circuit 56 includes power-recovery capacitor C31, switching elements Q31 and Q32, backflow preventing diodes D31 and D32, and resonance inductor L31. Clamping circuit 57 includes switching elements Q33 and Q34. Power supplied to data electrode Dk is recovered to power-recovery capacitor C31 by resonating electrode capacitance of data electrode Dk and resonance inductor L31 so as to generate the address pulse. At the same time, the address pulse generated is output to address pulse output circuit 58.

Address pulse output circuit 58 includes switch units OUT1 to OUTm for outputting an address pulse to each of data electrodes D1 to Dm. Each of switch units OUT1 to OUTm includes switching elements QH1 to QHm for outputting the address pulse output from address pulse generating circuit 55 to data electrodes D1 to Dm, and switching elements QL1 to QLm for grounding data electrodes D1 to Dm. The address pulse output from address pulse generating circuit 55 is output to data electrodes to apply the address pulse by switching the switching elements based on the timing signal output from timing generating circuit 45 and image data output from image signal processing circuit 41.

As already described, an extremely large discharge current needs to be traveled in data electrode drive circuit 42 in order to generate address discharge by driving data electrodes D1 to Dm. This results in generation of large Joule heating. In addition, since generation of address discharge varies depending on patterns of display images, the heat generated also greatly varies depending on patterns of display images.

Next, a structure of the image display device in the first exemplary embodiment of the present invention is described with reference to drawings. This exemplary embodiment describes a structure for accurately measuring a temperature of panel 10 so as to reliably drive the image display device by reducing an effect of the heat generated typically in drive circuits and signal processing circuit on thermal sensor 49.

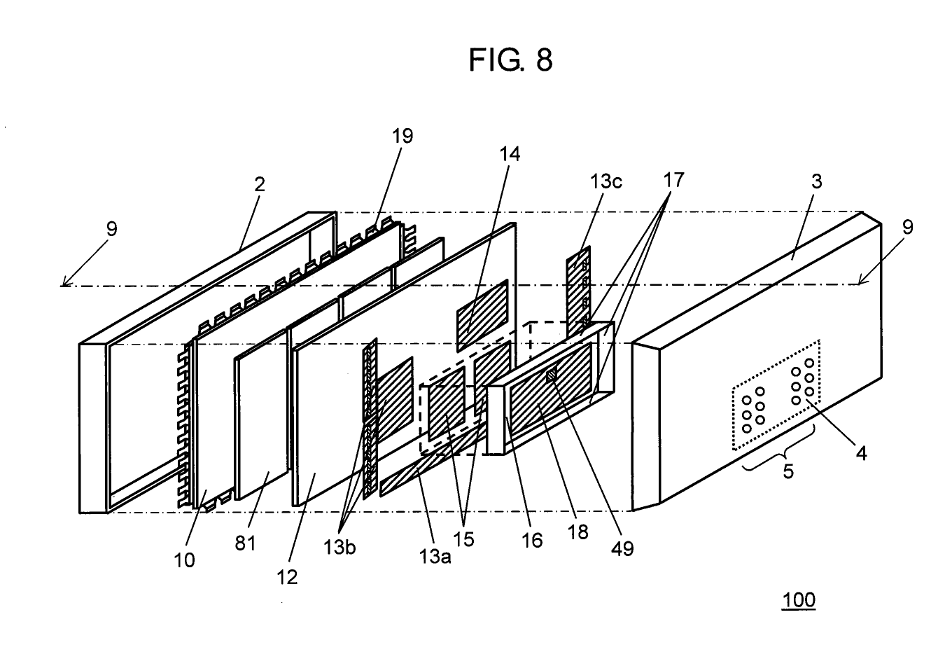

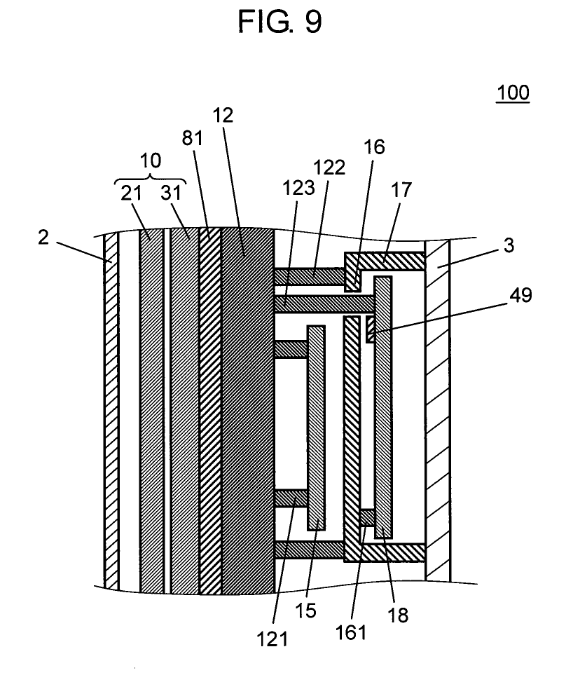

FIG. 8 is an exploded perspective view of an example of the structure of plasma display device 100 in the first exemplary embodiment of the present invention. FIG. 9 is a sectional view taken along line 9-9 in FIG. 8. Plasma display device 100 includes panel 10 as an image display unit for displaying an image; heat-conducting sheet 81; chassis 12; data electrode drive circuit board 13a, which is a printed circuit board where data electrode drive circuit 42 is mounted; scan electrode drive circuit board 13b, which is a printed circuit board where scan electrode drive circuit 43 is mounted; sustain electrode drive circuit board 13c, which is a printed circuit board where sustain electrode drive circuit 44 is mounted; power circuit board 14, which is a printed circuit board where a power circuit is mounted; small-signal processing circuit board 15, which is a printed circuit board where small signal processing circuits such as timing generating circuit 45 and image signal processing circuit 41 are mounted; tuner board 18, which is a printed circuit board where small-signal processing circuits such as timing generating circuit 45, image signal processing circuit 41, and thermal sensor 49 are mounted; thermal sensor fixture 16 with shielding wall 17 for thermally shielding tuner board 18; and a casing including front frame 2 and back cover 3, which is a rear frame, for housing panel 10 and aforementioned components. In the following description, the side of front frame 2 is the front face, and the side of back cover 3 is the rear face.

Heat-conducting sheet 81 is made of generally-known viscous silicone resin. This heat-conducting sheet 81 is interposed between rear plate 31 of panel 10 and chassis 12, and rear plate 31 of panel 10 and chassis 12 are attached. The heat generated in panel 10 is thus transmitted from rear plate 31 to chassis 12.

Chassis 12 is disposed on a rear face of panel 10, which is an image display unit for displaying images. Chassis 12 is made of a material mainly containing aluminum, which is a well-known material of light, rigid, and high heat conductivity. Chassis 12 holds panel 10 attached to it via heat-conducting sheet 81, and also releases the heat that is generated in panel 10 and transmitted via heat-conducting sheet 81. In addition, a boss (not illustrated in FIG. 8) for attaching a printed circuit board group and fixing back cover 3 is integrally formed on the rear face of chassis 12 by die-casting. Chassis 12 and the boss may also be configured by securing a fixing pin onto a flat aluminum sheet. More specifically, as shown in FIG. 9, the boss is configured with multiple boss members 121, 122, 123, and 161 provided on chassis 12.

Data electrode drive circuit board 13a, scan electrode drive circuit board 13b, sustain electrode drive circuit board 13c, and power circuit board 14 are fixed onto the boss on chassis 12 via boss member 121. A part of the printed circuit board group is electrically connected to a lead-out portion (not illustrated) led out to a non-display area of panel 10 by multiple flexible cables (FPC) 19 extended over four rims of chassis 12.

More specifically, data electrodes D1 to Dm on panel 10 and data electrode drive circuit board 13a are connected via FPC 19 connected to the lead-out portion of each of data electrodes D1 to Dm. This enables application of the drive voltage from data electrode drive circuit 42 to data electrodes D1 to Dm. In the same way, scan electrodes SC1 to SCn on panel 10 and scan electrode drive circuit board 13b are connected via FPC 19 connected to the lead-out portion of each of scan electrodes SC1 to SCn. This enables application of the drive voltage from scan electrode drive circuit 43 to scan electrodes SC1 to SCn. In the same way, sustain electrodes SU1 to SUn on panel 10 and sustain electrode drive circuit board 13c are connected via FPC 19 connected to the lead-out portion of each of sustain electrodes SU1 to SUn. This enables application of the drive voltage from sustain electrode drive circuit 44 to sustain electrodes SU1 to SUn. In this way, the drive voltage generated in each drive circuit board is applied to each electrode on panel 10. In each of drive circuit boards, a large current is generated in line with discharge current, and thus a large heat is generated.

Thermal sensor fixture 16 is fixed onto chassis 12 via boss member 122. Boss member 122 is longer than boss member 121 so as to dispose thermal sensor fixture 16 closer to back cover 3, than to the printed board group including each of drive circuit board and other circuits. This structure secures a broader distance between panel 10 and thermal sensor fixture 16, and thus the heat generated in panel 10 is efficiently released by chassis 12. In addition, thermal sensor fixture 16 has shielding wall 17. This shielding wall 17 shields the heat generated in each drive circuit board.

Shielding wall 17 is preferably formed around a printed circuit board where thermal sensor 49 is disposed. Shielding wall 17 may be made of a material mainly containing aluminum or iron, which is known as metal with good heat conductivity and is used for chassis 12 and boss member 122. However, shielding wall 17 is further preferably made of a material with low heat conductivity, such as resin. As described above, thermal sensor fixture 16 thermally shields aforementioned printed circuit board from the heat generated in each drive circuit board. Accordingly, thermal sensor 49 disposed on the printed circuit board is also thermally shielded from the heat generated in each drive circuit board.

A tuner circuit (not illustrated) for separating and taking out a television signal from broadcast signals received by an antenna (not illustrated) is mounted on tuner board 18. Tuner board 18 is fixed onto thermal sensor fixture 16 via boss member 161.

Boss member 123 is longer than boss member 122, and is disposed on chassis 12 around the center of panel 10. Thermal sensor fixture 16 has a hole with a size and at a position that boss member 123 can be passed through. Chassis 12 and tuner board 18 are fixed by boss member 123 passing through this hole in thermal sensor fixture 16.

The casing of plasma display device 100 is configured with back cover 3 and front frame 2, and houses panel 10 and aforementioned components. Back cover 3 also has ventilation area 5 including multiple ventilating holes 4 for ventilation between inside and outside of plasma display device 100.

Tuner board 18, which is a printed circuit board, is connected to a tip of boss member 123. Thermal sensor 49 is disposed on tuner board 18. More specifically, thermal sensor 49 is provided on a face of tuner board 18 to the side of front frame 2, and also at a position near a point where the tip of boss member 123 is fixed. In other words, thermal sensor 49, which is the first thermal sensor, is disposed on tuner board 18, which is the printed circuit board, at a fixing area of boss member 123. The fixing area of boss member 123 is provided preferably in an area of about 30-mm radius, for example, from a position where the tip of boss member 123 is fixed onto the printed circuit board in considering heat conductivity characteristics from panel 10 to thermal sensor 49. However, this radius depends on heat conductivity of a material of printed circuit board, and a thickness and area of copper foil present on the surface of the printed circuit board within this radius. Accordingly, this range is not limited. In other words, as long as the fixing area of boss member 123 is within 15-mm radius, for example, from a position where the tip of boss member 123 is fixed onto the printed circuit board, the heat of panel 10 transferred from boss member 123 can be further accurately and promptly transferred to thermal sensor 49. On the other hand, even if the fixing area of boss member 123 is within an area of about 60-mm radius from a position where the tip of boss member 123 is fixed onto the printed circuit board, the present invention is also applicable. Accordingly, thermal sensor 49 can accurately detect the temperature of panel 10 transferred through chassis 12 and boss member 123.

Boss member 123 is preferably made of a material with high heat conductivity same as chassis 12, such as aluminum or iron. In addition, to transfer the heat transmitted from boss member 123 only to thermal sensor 49, it is preferable that tuner board 18 is configured to be isolated from the position of thermal sensor 49, and from the positions of timing generating circuit 45 and image signal processing circuit 41. Still more, since air heated inside the casing of plasma display device 100 moves upward, thermal sensor 49 is preferably disposed to the lower end on tuner board 18 as much as possible. Furthermore, thermal sensor 49 is preferably set at a position not greater than a half the height of panel 10.

In other words, these structures makes the heat generated in panel 10 transferred to thermal sensor 49 via chassis 12 and boss member 123. Since thermal sensor 49 is thermally shielded, and not affected by the heat released from each drive circuit board, a value correlated to the temperature of panel 10 can be accurately detected. In addition, since back cover 3 has ventilation area 5 with multiple ventilating holes 4, changes in an external temperature of plasma display device 100 is also transmitted to thermal sensor 49. Accordingly, thermal sensor 49 can also detect a value correlated to the external temperature.

As described above, the image display device in this exemplary embodiment thermally transfers the heat of panel 10, which is the image display unit for displaying images, to thermal sensor 49 shielded by thermal sensor fixture 16 via boss member 123 that has high heat conductivity. This avoids the effect of the heat released from each drive circuit board, and thus enables reduction of detection error of thermal sensor 49. Accordingly, panel 10 can be driven most appropriately for the temperature of panel 10.

In the image display device in this exemplary embodiment, the first thermal sensor is provided on tuner board 18 to the side of front frame 2 in the fixing area of boss member 123. However, the present invention is not limited to this structure. In other words, as long as first thermal sensor 49 is provided in the fixing area of boss member 123, first thermal sensor 49 may be disposed on the printed circuit board to the side of back cover 3, which is the rear frame. In this case, a notch or groove is crated around first thermal sensor 49 on tuner board 18 so as to reduce heat conduction from the tuner circuit and to accurately detect a value correlated to the temperature of panel 10.

### Second Exemplary Embodiment

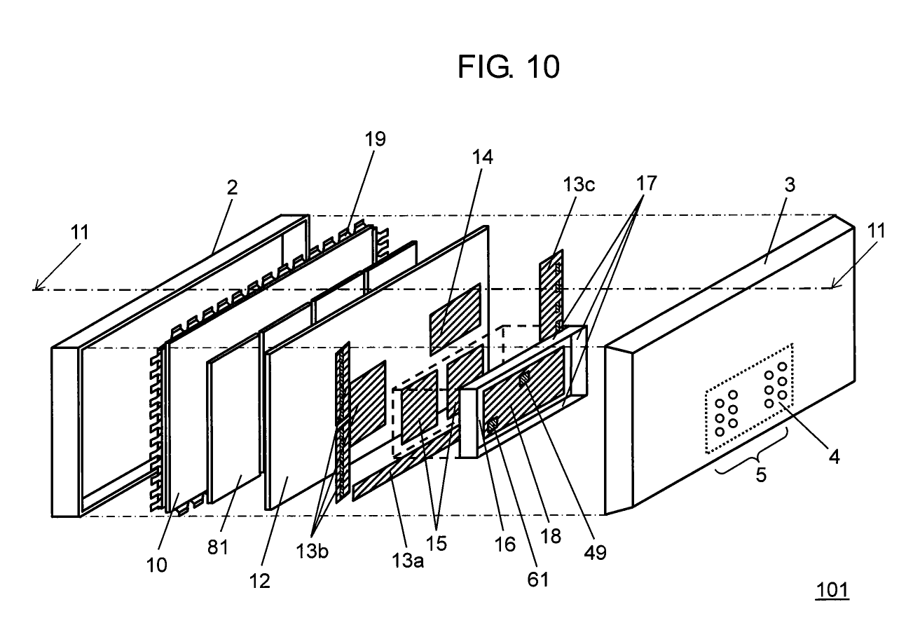

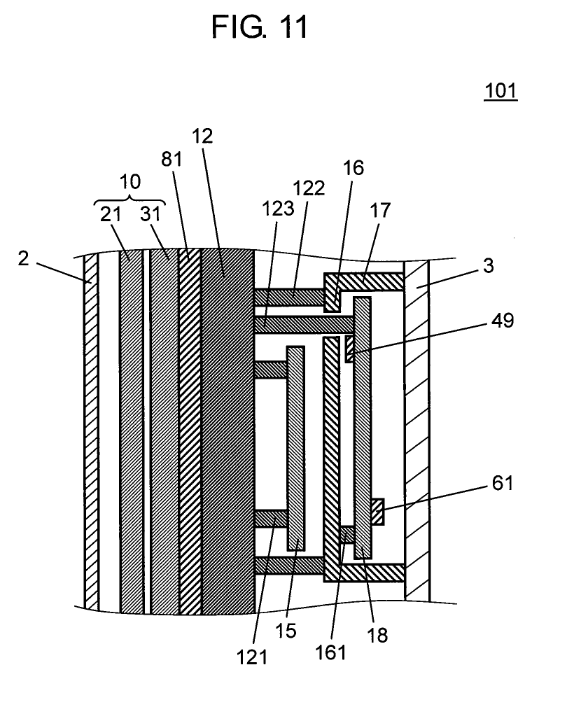

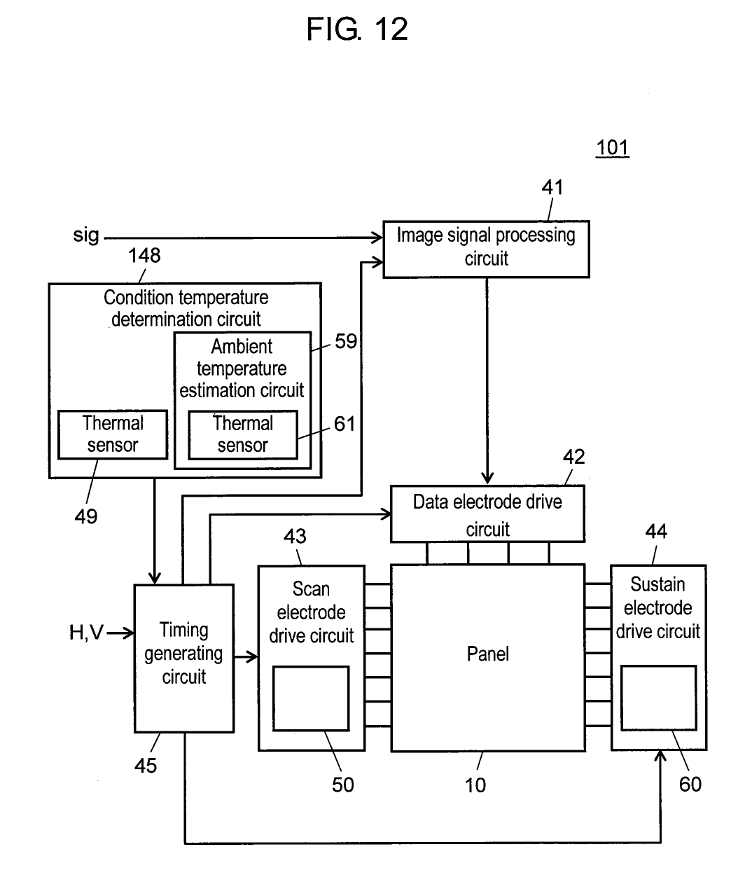

FIG. 10 is an exploded perspective view of an example of a structure of plasma display device 101 as an image display device in the second exemplary embodiment of the present invention. FIG. 11 is a sectional view taken along line 11-11 in FIG. 10. FIG. 12 is a circuit block diagram of plasma display device 101 in the second exemplary embodiment of the present invention. The structure of panel 10 of the image display device and an outline of drive voltage waveform in the second exemplary embodiment of the present invention are the same as that of the first exemplary embodiment. A point that differs from the first exemplary embodiment is, as shown in FIG. 12, that the second exemplary embodiment further includes ambient temperature estimation circuit 59 having thermal sensor 61, which is the second thermal sensor, and condition temperature determination circuit 148. Condition temperature determination circuit 148 detects a temperature of panel 10, which is an image display unit, and the ambient temperature by using two thermal sensors: The first thermal sensor and the second thermal sensor. Then, condition temperature determination circuit 148 calculates a condition temperature based on the detected temperature of panel 10 and ambient temperature. A detailed method of calculating a condition temperature is described later.

In FIG. 10, the same reference marks are given to the same parts as plasma display device 100 shown in FIG. 8 in the first exemplary embodiment, and their detailed description is omitted. Also in FIG. 11, the same reference marks are given to the same parts as plasma display device 100 shown in FIG. 9 in the first exemplary embodiment, and their detailed description is omitted.

As described above, thermal sensor 49, which is the first thermal sensor, is disposed on tuner board 18, which is a printed circuit board, to the side of front frame 2. Thermal sensor 61, which is the second thermal sensor, is disposed on tuner board 18 to the side of back cover 3, where shielded by shielding wall 17 of thermal sensor fixture 16. Thermal sensor 61 is disposed without making contact with back cover 3 at a position that no blocking substance is interposed between ventilation area 5 and thermal sensor 61. In other words, thermal sensor 61, which is the second thermal sensor, is disposed on tuner board 18, which is a printed circuit board, at a position facing back cover 3, which is the rear frame. This structure reduces the effect of the heat generated in panel 10 and the heat released from each drive circuit board, and enables accurate detection of the ambient temperature of plasma display device 101.

In the casing of plasma display device 101, heated air moves upward. Accordingly, thermal sensor 61 is preferably disposed on tuner board 18 at the position facing back cover 3 and at a lower end of tuner board 18, as much as possible. Furthermore, thermal sensor 61 is preferably disposed at a position not higher than a half the height of panel 10. This structure ensures smooth entrance and convection of external air from ventilation area 5 of plasma display device 101 to around thermal sensor 61 because there is no blocking substance between ventilation area 5 on back cover 3 and thermal sensor 61. As a result, the effect of the heat released from each drive circuit board reduces, and thus the ambient temperature of plasma display device 101 can be accurately detected.

Next, a structure of the image display device in this exemplary embodiment is detailed with reference to FIG. 12.

Condition temperature determination circuit 148 includes thermal sensor 49 and ambient temperature estimation circuit 59 having similar thermal sensor 61. Thermal sensor 49 is formed of a well-known element, such as a thermocouple, for detecting temperatures.

Thermal sensor 61 is disposed inside the casing of plasma display device 101 so as to measure a temperature close to the ambient temperature of plasma display device 101, and output a detected value to ambient temperature estimation circuit 59.

Ambient temperature estimation circuit 59 corrects an output of thermal sensor 61 taking into account an effect of the heat generated in the tuner circuit. This correction is necessary because the tuner circuit continuously executes a certain operation, regardless of display images, and thus it increases the output of thermal sensor 61 for a certain amount of temperature. Accordingly, ambient temperature estimation circuit 59 calculates an ambient temperature estimation value by subtracting this certain amount of temperature rise from the output of thermal sensor 61, and outputs this ambient temperature estimation value to condition temperature determination circuit 148. In the following description, a temperature rise due to the tuner circuit is called offset γ.

Condition temperature determination circuit 148 calculates the temperature of panel 10 based on two inputs from thermal sensor 49 and ambient temperature estimation circuit 59. This calculated temperature of panel 10 is called a condition temperature.

Drive modes of panel 10 are divided into three levels for low temperature, normal temperature, and high temperature. In other words, condition temperature determination circuit 148 compares a calculated temperature of panel 10 with predetermined temperature thresholds for low temperature (ex. Less than 17° C.), normal temperature (ex. 17° C. to less than 48° C.), and high temperature (ex. 48° C. or higher), respectively. Then, condition temperature determination circuit 148 outputs this comparison result to timing generating circuit 45. Based on this result, the drive mode appropriate for the calculated temperature of panel 10 is selected. In this way, condition temperature determination circuit 148 in the second exemplary embodiment of the present invention calculates a condition temperature for selecting the drive mode of panel 10.

Next, a specific operation of each component is described. As already described, boss member 123 with high conductivity, such as aluminum, is interposed between chassis 12 with panel 10 and thermal sensor 49. Accordingly, thermal sensor 49 can obtain an output with less detection error relative to the temperature of panel 10. Then, this output is output to condition temperature determination circuit 148. In the following description, the output of thermal sensor 49 is called Tp.

Thermal sensor 61 is disposed such that a distance is secured against panel 10, as already described, so that thermal sensor 61 can measure a temperature close to the ambient temperature of plasma display device 101, as much as possible. Accordingly, thermal sensor 61 can obtain an output with less temperature error relative to the effect of the heat generated in panel 10. Then, this output is output to ambient temperature estimation circuit 59. This output of thermal sensor 61 is called Tss in the following description. Output Tss of thermal sensor 61 is affected by the heat generated in a circuit on tuner board 18 where thermal sensor 61 is mounted. Therefore, output Tss is corrected in ambient temperature estimation circuit 59 as follows.

Ambient temperature estimation circuit 59 corrects output Tss of thermal sensor 61 with respect to a temperature rise due to the tuner circuit, and outputs a corrected value to condition temperature determination circuit 148. More specifically, output Ts of ambient temperature estimation circuit 59 can be expressed by next Formula 1 when the output of ambient temperature estimation circuit 59 is Ts and the temperature rise due to tuner circuit is offset γ.

Ts=Tss−γ (Formula 1)

### Whereas,

Ts: Output of ambient temperature estimation circuit 59 (° C.)
Tss: Output of thermal sensor 61 (° C.)
γ: Offset of temperature rise due to the tuner circuit (° C.)
Here, Offset γ is, for example, 10° C. However, this value is an example, and thus differs by design conditions such as of the panel. Accordingly, condition temperature determination circuit 148 receives a highly accurate temperature calculated based on outputs of two thermal sensors. This improves the accuracy of calculation of a condition temperature, as described below.

Next, how the condition temperature is calculated in condition temperature determination circuit 148 is detailed. Condition temperature determination circuit 148 corrects output Tp of thermal sensor 49 so as to reduce the effect of heat source other than the panel. Now, major roles of two thermal sensors 49 and 61 in the second exemplary embodiment of the present invention are described. As already described, both thermal sensors 49 and 61 are disposed at positions thermally shielded so as to avoid the effect of the heat generated from each drive circuit board. In addition, thermal sensor 49 is configured such that it is easily affected by a temperature change in panel 10. On the other hand, thermal sensor 61 is configured such that it is less affected by a temperature change in panel 10. Accordingly, when Tdiff is a difference between outputs of the two thermal sensors, difference Tdiff in outputs and a temperature change in panel 10 have a strong correlation. In other words, it can be predicted that a temperature rise in panel 10 is small when difference Tdiff of outputs is small, and a temperature rise in panel 10 is large when difference Tdiff of outputs is large. Accordingly, threshold Tth for difference Tdiff of outputs is set to plasma display device 101 in advance so that the output of thermal sensor 49 can be accurately corrected by comparing difference Tdiff of outputs and threshold Tth.

However, the effect of a circuit on tuner board 18 is significantly larger than that of the temperature of panel 10 in a transition period until the temperature rise of tuner board 18, where two thermal sensors are mounted, is saturated. Accordingly, difference Tdiff of outputs becomes small, regardless of an amount of temperature change in panel 10. This is because a passage of heat conduction from circuit, such as a tuner, on tuner board 18 to thermal sensor 49 and a passage of heat conduction from panel 10 to thermal sensor 49 via boss member 123 are long, and thus it takes long time until saturation. Therefore, another correction is applied to thermal sensor 49 in the transition period. More specifically, a different formula is applied for correction using output Tp of thermal sensor 49, which is the first thermal sensor, so as to calculate the temperature of panel 10.

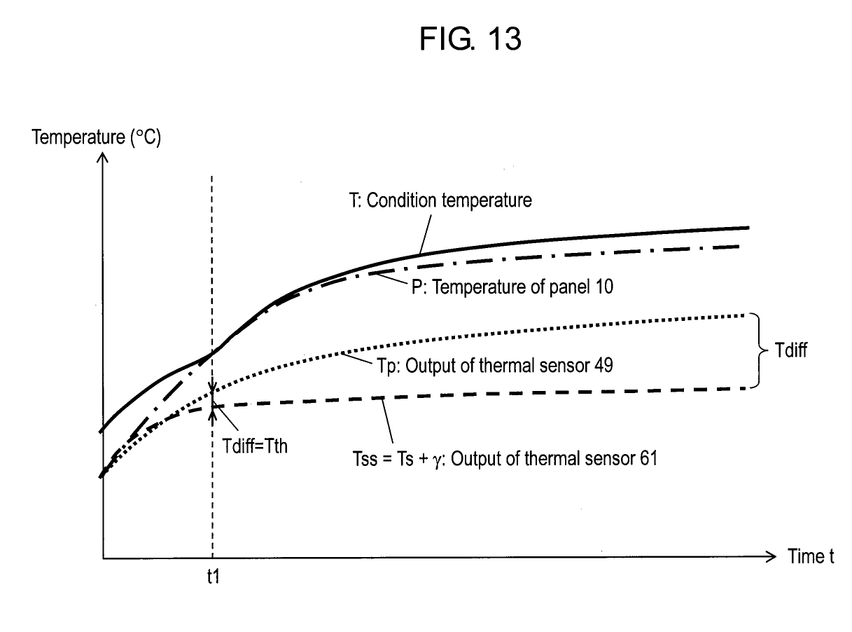

The above correction is detailed below. FIG. 13 illustrates the relationship of output Tp of thermal sensor 49, output Tss of thermal sensor 61, temperature P of panel 10, and condition temperature T, relative to the time after the power is turned on to display an all-white image on the entire screen of plasma display device 101 in the second exemplary embodiment of the present invention. Temperature P of panel 10 is experimentally measured for confirming the correction accuracy. In FIG. 13, the all-white image is displayed on the entire screen of panel 10.

First, a period after the temperature rise of tuner board 18 is saturated is described. An increase due to the temperature of output Tss from thermal sensor 61 saturates at around t1. On the other hand, output Tp of thermal sensor 49 increases in line with the temperature rise in temperature P of panel 10. Accordingly, temperature P of panel 10 is assumed to be higher than output Tp of thermal sensor 49 when difference Tdiff of the outputs exceeds threshold Tth preset in plasma display device 101. Therefore, a correction expressed by Formula 2 below is applied to condition temperature T. Predetermined threshold Tth is, for example, 5° C. However, this value is just an example, and thus differs depending on design conditions such as of the panel.

T=Tp+α·Tdiff

=Tp+α (Tp−Tss)

=Tp+α {Tp−(Ts+γ)} (Formula 2)

### Whereas,

T: Condition temperature (° C.)
Tp: Output of thermal sensor 49 (° C.)
Tdiff: Difference in outputs of two thermal sensors (° C.)
Tss: Output of thermal sensor 61 (° C.)
Ts: Output of ambient temperature estimation circuit 59 (° C.)
α: Correction coefficient preset in plasma display device 101. For example, α is 1.2. However, this value is just an example, and thus differs depending on design conditions such as of the panel.

As described above, if difference Tdiff of the outputs in the period after the temperature rise of tuner board 18 is saturated is greater than threshold Tth, condition temperature determination circuit 148 may apply predetermined correction efficient α to difference Tdiff between output Tp of thermal sensor 49, which is the first thermal sensor, and output Tss of thermal sensor 61, which is the second thermal sensor, so as to calculate a temperature rise in the image display unit.

However, in a period before the temperature rise of tuner board 18 is saturated, as already described, difference Tdiff of the outputs is small, regardless of temperature P of panel 10. Accordingly, if temperature P of panel 10 is high, due to a high ambient temperature, condition temperature determination circuit 148 may execute erroneous correction in the period before the temperature rise is saturated. Accordingly, time t1 for determining the end of the transition period and threshold Thot relative to ambient temperature estimation value Ts are preset in plasma display device 101 so as to apply correction shown in Formula 3 below to condition temperature T when time t after the power of plasma display device 101 is turned on is smaller than t1 and condition temperature estimation value Ts is greater than threshold Thot. For example, threshold Thot is 20° C. However, this is just an example, and thus differs depending on design conditions such as of the panel.

T=Tp+Hc (Formula 3)

### Whereas,

T: Condition temperature (° C.)
Tp: Output of thermal sensor 49 (° C.)
Hc: Correction amount (° C.) preset in plasma display device 101. For example, Hc is 4° C. However, this is just an example, and thus differs depending on design conditions such as of the panel.

As described above, condition temperature T that follows the temperature of panel 10 can be calculated by detecting the case when temperature P of panel 10 is higher than the output of thermal sensor 49.

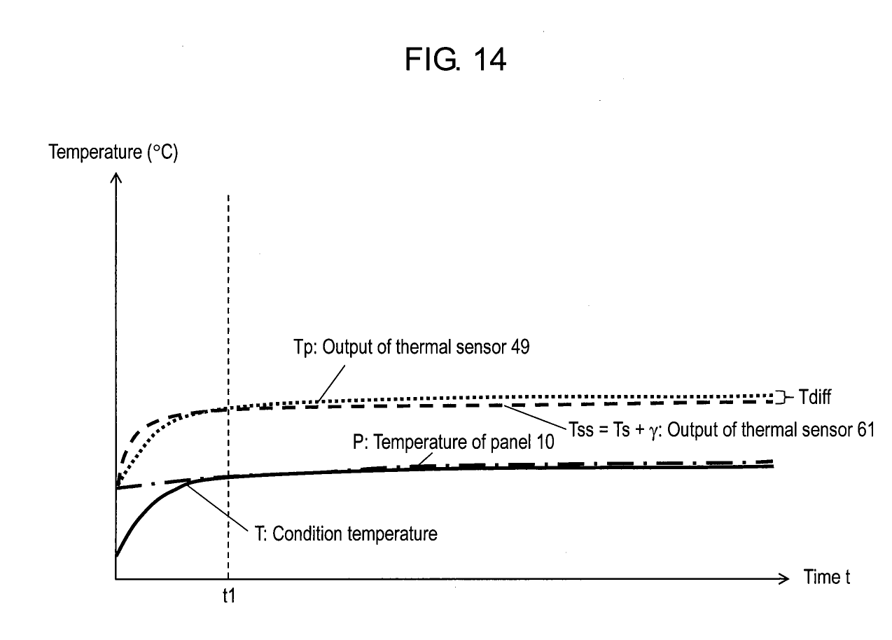

FIG. 14 illustrates the relationship of output Tp of thermal sensor 49, output Tss of thermal sensor 61, temperature P of panel 10, and condition temperature T, relative to the time after the power is turned on, when an all-black image is displayed on the entire screen of plasma display device 101 in the second exemplary embodiment of the present invention. Temperature P of panel 10 is experimentally measured for confirming the correction accuracy. In FIG. 14, the all-black image is displayed on the entire screen of panel 10.

As shown in FIG. 14, temperature P of panel 10 becomes almost constant after time t1. Then, a temperature rise in output Tp of thermal sensor 49 becomes extremely small, and difference Tdiff of outputs also becomes small. Accordingly, temperature P of panel 10 is lower than output Tp of thermal sensor 49 when difference Tdiff of the outputs is smaller than threshold Tth, and thus a change is estimated to be small. In this case, a correction expressed by Formula 4 below is applied to condition temperature T.

T=Tp−β (Formula 4)

### Whereas,

T: Condition temperature (° C.)
Tp: Output of thermal sensor 49 (° C.)
β: Correction amount (° C.) preset in plasma display device 101. For example, β is 5° C. However, this is just an example, and thus differs depending on design conditions such as of the panel.

As described above, condition temperature determination circuit 148 calculates condition temperature T that follows temperature P of panel 10 by detecting the case that temperature P of panel 10 is lower than output Tp of thermal sensor 49.

Accordingly, condition temperature determination circuit 148 can accurately calculate the temperature of panel 10. As already described, correction coefficient α, correction β and Hc, transition period t1, threshold Tth for difference Tdiff of outputs of two thermal sensors, and threshold Thot for ambient temperature estimation value Ts that are present in plasma display device 101 are adjusted depending on the size and characteristics of panel 10. In addition, further accurate calculation is achievable by adjusting correction coefficient a and correction amounts β and Hc depending on ambient temperature estimation value Ts.

In this exemplary embodiment, an effective element on temperature P of panel 10 is extracted from two thermal sensors that receive different effects from temperature P of panel 10 so that a detection error due to positions of the thermal sensors can be reduced in order to calculate a highly accurate condition temperature. Accordingly, panel 10 can be driven in the most appropriate way for the temperature condition of panel 10.

The exemplary embodiment refers to the structure for improving the detection accuracy of temperature P of panel 10. However, it is apparent that the detection accuracy of ambient temperature can also be improved using a similar structure. For example, in aforementioned Formula 2, the detection accuracy of ambient temperature can be improved by replacing condition temperature T with corrected ambient temperature Tt, output Tp of thermal sensor 49 with output Tss of ambient thermal sensor, α with ambient temperature correction coefficient, and difference Tdiff of outputs with increase ΔTp in panel thermal sensor. This can be expressed as Formula 5. Here, increase ΔTp in panel thermal sensor is an increase in the output of thermal sensor 49 from a reference temperature when the reference temperature is ambient temperature of 25° C.

Tt=Tss−k·ΔTp

Tt: Corrected ambient temperature (° C.)
Tss: Output of thermal sensor 61 (° C.)
ΔTp: Temperature increase in thermal sensor 49 (° C.)
k: Correction coefficient for ambient temperature preset to plasma display device 101. For example, k is 1.2. However, this is just an example, and thus differs depending on design conditions such as of the panel.

As described above, condition temperature determination circuit 148 may calculate corrected ambient temperature Tt by multiplying temperature increase ΔTp in the output of thermal sensor 49, which is the first thermal sensor, by predetermined correction coefficient a, and subtracting this value from output Tss of thermal sensor 61, which is the second thermal sensor. As a result, the detection accuracy of the ambient temperature can be further improved. Since condition temperature T can be calculated using corrected ambient temperature Tt as output Tss of thermal sensor 61 in Formula 2, the temperature of panel 10 can be further accurately calculated. Accordingly, panel 10 can be driven further appropriately for temperature condition of panel 10.

The image display device in this exemplary embodiment enables accurate calculation of the temperature of the image display unit even if the image display device includes an image display unit that generates a large heat value, such as a plasma display panel and surface conduction electron-emitter display panel. Accordingly, the image display device can be driven using an appropriate mode based on a calculated temperature of image display unit. In addition, the temperature of image display unit can be maintained at an appropriate level. As a result, a high-quality image can be displayed.

The image display device in this exemplary embodiment employs a plasma display panel as its panel. However, other panels, including a liquid crystal panel and SED panel, are also applicable.

### INDUSTRIAL APPLICABILITY

The present invention adopts a relatively simple structure for keeping an appropriate panel temperature in a plasma display device with a large screen and high luminance. This achieves high-quality image display. Accordingly, the present invention is efficiently applicable to image display devices.

1. An image display device comprising:
an image display unit for displaying an image;
a chassis disposed on a rear face of the image display unit;
a boss member disposed on the chassis;
a printed circuit board connected to a tip of the boss member;
a first thermal sensor disposed on the printed circuit board at a fixing area of the boss member;
a thermal sensor fixture having a shielding wall for thermally shielding the printed circuit board; and
a casing including a front frame and a rear frame, the casing housing the image display unit and the thermal sensor fixture.

2. The image display device of claim 1, further comprising:
a second thermal sensor disposed on the printed circuit board at a position facing the rear frame; and
a condition temperature determination circuit for calculating a temperature of the image display unit based on the first thermal sensor and the second thermal sensor.

3. The image display device of claim 2,
wherein the first thermal sensor is disposed at a side of the front frame of the printed circuit board, and the second thermal sensor is disposed at a side of the rear frame of the printed circuit board.

4. The image display device of claim 2,
wherein the condition temperature determination circuit calculates a temperature increase in the image display unit by applying a predetermined correction coefficient to a difference between an output of the first thermal sensor and an output of the second thermal sensor.

5. The image display device of claim 2,
wherein the condition temperature determination circuit uses a different formula depending on an output of the first thermal sensor.

6. The image display device of claim 1,
wherein the image display unit is a plasma display panel.

7. The image display device of claim 2,
wherein the condition temperature determination circuit multiplies a temperature increase in an output of the first thermal sensor by a predetermined ambient temperature correction coefficient to obtain a value, and
subtracts the value from an output of the second thermal sensor;
so as to calculate a corrected ambient temperature.

8. The image display device of claim 2,
wherein the first thermal sensor and the second thermal sensor are disposed at a side of the rear frame of the printed circuit board, and one of a notch and a groove is provided around the first thermal sensor on the printed circuit board.
